(19) United States
(12) Patent Application Publication
(10) Pub. No.: US 2021/0304452 A1
(43) Pub. Date: Sep. 30, 2021

(54) METHOD AND SYSTEM FOR PROVIDING AVATAR SERVICE

(71) Applicant: LINE PLUS CORPORATION, Seongnam-si (KR)

(72) Inventor: Yunji LEE, Seongnam-si (KR)

(73) Assignee: LINE PLUS CORPORATION, Seongnam-si (KR)

(21) Appl. No.: 17/214,065

(22) Filed: Mar. 26, 2021

(30) Foreign Application Priority Data
Mar. 27, 2020 (KR) 10-2020-0037521

(51) Int. Cl. G06T 11/00; G06T 7/194; G06K 9/00; G06K 9/62; G06T 7/70; G06T 7/50; G06T 7/60; H04L 12/58

(52) U.S. Cl. CPC G06T 11/00; G06T 7/194; G06K 9/00288; G06K 9/6215; G06T 2207/20212; G06T 7/50; G06T 7/60; H04L 51/10; G06T 2207/30201; G06T 7/70

(57) ABSTRACT

A method for providing an avatar service may include: receiving an original image including a person object from a user terminal through an instant messaging application; extracting skeleton information of the person object, from the original image; identifying a user account of the instant messaging application associated with the person object; and removing the person object from the original image to convert the original image to a background image.

### CROSS-REFERENCE TO RELATED APPLICATION

This application claims priority under 35 U.S.C § 119 to Korean Patent Application No. 10-2020-0037521, filed in the Korean Intellectual Property Office on March 27, 2020, the disclosure of which is incorporated by reference herein in its entirety.

### BACKGROUND

### 1. Technical Field

The present disclosure relates to a method and a system for providing an avatar service, and more particularly, to a method and a system for generating a synthesis image using an avatar to provide the avatar service.

### 2. Description of Related Art

There is a widespread distribution of camera-attached terminals, such as smartphones, tablet personal computers (PCs), laptop computers, desktop computers, and the like. In this environment, a growing number of users utilize cameras attached to terminals. Also, services are provided to allow a user to use the camera in association with an avatar which represents the user's role in a virtual space.

Various technologies for replacing the shape of a person included in a captured image with an avatar are provided, but there is an inconvenience in that the user has to select the avatar and set a pose of the avatar manually. In particular, it is not easy for laypersons to make a realistic avatar that is similar to the shape of the person included in the captured image.

### SUMMARY

One or more example embodiments provide a method, a non-transitory computer-readable recording medium, an apparatus, and a system for automatically generating a realistic avatar that reflects a shape and a pose of a person included in a captured image to provide an avatar service.

The avatar may have a pose that is the same as or similar to the pose of the person in the captured image (also referred to as a person object in the captured image), based on information extracted from the person object.

According to an aspect of an example embodiment, there is provided a method for providing an avatar service, by one or more processors, the method including: receiving an original image including a first person object from a user terminal through an instant messaging application; extracting skeleton information of the first person object, from the original image; identifying a first user account of the instant messaging application associated with the first person object; and removing the first person object from the original image to convert the original image to a background image.

The method may further include: generating a synthesis image in which the first person object is replaced with an avatar based on first avatar information associated with the first user account and the skeleton information of the first person object.

The method may further include: transmitting first avatar information associated with the first user account, the skeleton information of the first person object, and the background image to the user terminal.

The removing the first person object from the original image to generate the background image may include: changing, in the original image, a first pixel value in a first area corresponding to the first person object based on a second pixel value in a second area other than the first area corresponding to the first person object.

The identifying the first user account of the instant messaging application associated with the first person object may include: comparing a face area in the first person object with face information of the first user account of the instant messaging application associated with the user terminal.

The method may further include: obtaining the face information of the first user account based on at least one of an image included in profile information of the first user account and at least one video call image received from the user terminal.

The identifying the first user account of the instant messaging application associated with the first person object may include: comparing a face area in the first person object with face information of a second user account of an acquaintance of the first user account.

The generating the synthesis image may include: converting the skeleton information of the first person object into avatar skeleton information based on the first avatar information; generating an avatar image based on the avatar skeleton information and the first avatar information; and inserting the avatar image into the background image.

The method may further include: in response to determining that there is no avatar information associated with the first user account, searching for an avatar having a highest similarity to the first person object.

The original image may include information of a camera angle indicating an angle of a camera at a time when the original image is captured by the camera, and the method for providing the avatar service may further include: generating a synthesis image in which the first person object is replaced with an avatar based on first avatar information associated with the first user account, the skeleton information of the first person object, and the information of the camera angle.

The method may further include: estimating a camera angle of the original image; and generating a synthesis image in which the first person object is replaced with an avatar based on first avatar information associated with the first user account, the skeleton information of the first person object, and the camera angle.

The original image may further include a second person object, and the method for providing the avatar service may further include: extracting skeleton information of the second person object, from the original image; detecting a second user account of the instant messaging application associated with the second person object; and determining a difference in depth between the first person object and the second person object in the original image, wherein the removing the first person object from the original image to convert the original image to the background image may include: removing the second person object from the original image to convert the original image to the background image, and wherein the generating the synthesis image may include: generating the synthesis image based on the first avatar information, second avatar information associated with the second user account, the skeleton information of the first person object, the skeleton information of the second person object, and the difference in depth.

The determining the difference in depth between the first person object and the second person object in the original image may include at least one of: comparing a first foot position of the first person object with a second foot position of the second person object; comparing a first face size of the first person object with a second face size of the second person object; and comparing a first image depth of the first person object and a second image depth of the second person object based on depth information included in the original image.

The detecting the first user account of the instant messaging application associated with the first person object may include: in response to determining that the first person object is at least one of a side view and a back view of a first person, transmitting a message, which requests information on the first user account associated with the first person object to the user terminal through the instant messaging application.

The identifying the first user account of the instant messaging application associated with the first person may include: transmitting, as identified user account information, the first user account to the user terminal through the instant messaging application; and receiving, as corrected user account information, a second user account that is different from the first user account, from the user terminal through the instant messaging application.

The extracting the skeleton information of the first person object may include: determining whether or not a size of an area corresponding to the first person object is equal to or greater than a preset threshold value.

According to an aspect of another example embodiment, there is provided a method for providing an avatar service by one or more processors, the method including: receiving an original image including a person object; transmitting the original image to an external device through an instant messaging application; obtaining skeleton information of the person object; receiving avatar information associated with the person object from the external device; obtaining a background image in which the person object is removed from the original image; and generating a synthesis image in which the person object in the original image is replaced with an avatar, based on the skeleton information, the avatar information, and the background image.

The generating the synthesis image may include: converting the skeleton information of the person object into avatar skeleton information based on the avatar information; generating the avatar based on the avatar skeleton information and the avatar information; and inserting the avatar into the background image.

The original image may include information of a camera angle indicating an angle of a camera at a time when the original image is captured by the camera, and the generating the synthesis image may include: generating the synthesis image based on the avatar information, the skeleton information of the person object, and the information of the camera angle.

The obtaining the skeleton information of the person object may include: receiving the skeleton information of the person object from the external device, or extracting the skeleton information of the person object from the original image; wherein the obtaining the background image may include: when the skeleton information of the person object is received from the external device, receiving the background image from the external device; and when the one or more processors have extracted the skeleton information from the original image, generating the background image by removing the person object from the original image.

According to an aspect of another example embodiment, there is provided a server for providing an avatar service, the server including: one or more memories configured to store one or more instructions; and one or more processors configured to execute the one or more instructions to: receive an original image including a person object, from a user terminal through an instant messaging application; extract skeleton information of the person object, from the original image; identify a user account of the instant messaging application associated with the person object; and convert the original image to a background image by removing the person object from the original image.

### BRIEF DESCRIPTION OF THE DRAWINGS

The above and/or other aspects will be more apparent by describing certain example embodiments, with reference to the accompanying drawings, in which:

FIG. 1 is a diagram illustrating an example in which a user terminal generates a synthesis image in which a person object is replaced with an avatar according to an embodiment;

FIG. 2 is a schematic diagram illustrating a configuration in which an information processing system is communicatively connected to a plurality of user terminals in order to generate a synthesis image in which a person object is replaced with an avatar according to an embodiment;

FIG. 3 is a block diagram illustrating an internal configuration of the user terminal and the information processing system according to an embodiment;

FIG. 4 is a flowchart illustrating a method for providing an avatar service according to an embodiment;

FIG. 5 is a diagram illustrating an example of extracting skeleton information of a person object from an image according to an embodiment;

FIG. 6 is a diagram illustrating an example of removing a person object from an image to generate a background image according to an embodiment;

FIG. 7 is a diagram illustrating an example of generating a synthesis image by converting skeleton information of a person object into avatar skeleton information according to an embodiment;

FIG. 8 is a diagram illustrating an example in which an information processing system transmits and receives information to and from a user terminal according to an embodiment;

FIG. 9 is a flowchart illustrating an example of a method for generating a synthesis image in which a person object is replaced with an avatar based on an image capturing angle according to an embodiment;

FIG. 10 is a diagram illustrating an example of replacing a person object with an avatar by reflecting a capturing viewpoint of a camera according to an embodiment; and

FIG. 11 is a diagram illustrating an example in which three users are captured, in which avatars are rendered in the order of the users appearing in front, according to an embodiment.

### DETAILED DESCRIPTION

Example embodiments are described in greater detail below with reference to the accompanying drawings.

In the following description, like drawing reference numerals are used for like elements, even in different drawings. The matters defined in the description, such as detailed construction and elements, are provided to assist in a comprehensive understanding of the example embodiments. However, it is apparent that the example embodiments can be practiced without those specifically defined matters. Also, well-known functions or constructions are not described in detail since they would obscure the description with unnecessary detail.

The terms used herein will be briefly described prior to describing the disclosed embodiments in detail. The terms used herein have been selected as general terms which are widely used at present in consideration of the functions of the present disclosure, and this may be altered according to the intent of an operator skilled in the art, conventional practice, or introduction of new technology. In addition, in a specific case, a term is arbitrarily selected by the applicant, and the meaning of the term will be described in detail in a corresponding description of the embodiments. Therefore, the terms used in the present disclosure should be defined based on the meaning of the terms and the overall contents of the present disclosure rather than a simple name of each of the terms.

As used herein, the singular forms “a,” “an,” and “the” are intended to include the plural forms as well, unless the context clearly indicates the singular forms. Further, the plural forms are intended to include the singular forms as well, unless the context clearly indicates the plural forms. Further, throughout the description, when a portion is stated as “comprising (including)” a component, it intends to mean that the portion may additionally comprise (or include or have) another component, rather than excluding the same, unless specified to the contrary.

Further, the term “module” or “unit” used herein refers to a software or hardware component, and “module” or “unit” performs certain roles. However, the meaning of the “module” or “unit” is not limited to software or hardware. The “module” or “unit” may be configured to be in an addressable storage medium or configured to reproduce one or more processors. Accordingly, as an example, the “module” or “unit” may include components such as software components, object-oriented software components, class components, and task components, and at least one of processes, functions, attributes, procedures, subroutines, program code segments of program code, drivers, firmware, micro-codes, circuits, data, database, data structures, tables, arrays, and variables. Furthermore, functions provided in the components and the “modules” or “units” may be combined into a smaller number of components and “modules” or “units”, or further divided into additional components and “modules” or “units.”

Expressions such as “at least one of,” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples.

While such terms as “first,” “second,” etc., may be used to describe various elements, such elements must not be limited to the above terms. The above terms may be used only to distinguish one element from another.

According to an embodiment of the present disclosure, the “module” or “unit” may be implemented as a processor and a memory. The “processor” should be interpreted broadly to encompass a general-purpose processor, a central processing unit (CPU), a microprocessor, a digital signal processor (DSP), a controller, a microcontroller, a state machine, and so forth. Under some circumstances, the “processor” may refer to an application-specific integrated circuit (ASIC), a programmable logic device (PLD), a field-programmable gate array (FPGA), and so on. The “processor” may refer to a combination of processing devices, e.g., a combination of a DSP and a microprocessor, a plurality of microprocessors, one or more microprocessors in conjunction with a DSP core, or any other combination of such configurations. In addition, the “memory” should be interpreted broadly to encompass any electronic component capable of storing electronic information. The “memory” may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, and so on. The memory is said to be in electronic communication with a processor if the processor can read information from and/or write information to the memory. The memory that is integral to a processor is in electronic communication with the processor.

In the present disclosure, the “user account” may represent an account generated and used by a user in an instant messaging application or data related thereto. In addition, the user account of the instant messaging application may refer to a user who uses the instant messaging application. Likewise, a user who uses instant messaging or a chat room capable of instant messaging may refer to a user account of the instant application. Further, the user account may include one or more user accounts.

In the present disclosure, the “skeleton information” may represent information that may represent a shape of a person object using straight lines and curves that connect boundaries of the shape. The skeleton information may provide geometrical and topological properties of the shape of the person object. The straight line may be information indicating a straight part such as an arm and a leg from a joint part to another joint part, or from a joint part to an end of the arm/leg, and the curve may be information indicating a round part such as a head. In an embodiment, circles, ellipses, polygons, and the like may be used instead of the straight lines and the curves. A thinning algorithm may be applied to transform a captured image into a topologically equivalent image, such as a skeleton image.

In the present disclosure, the “background image” may be an image from which a person object is adaptively removed. In an embodiment, it may be possible to remove only a specific person object that satisfies a predetermined requirement among a plurality of person objects in the image. Accordingly, the background image may include one or more person objects (for example, which are smaller than a predetermined size) while the specific person object is removed therefrom.

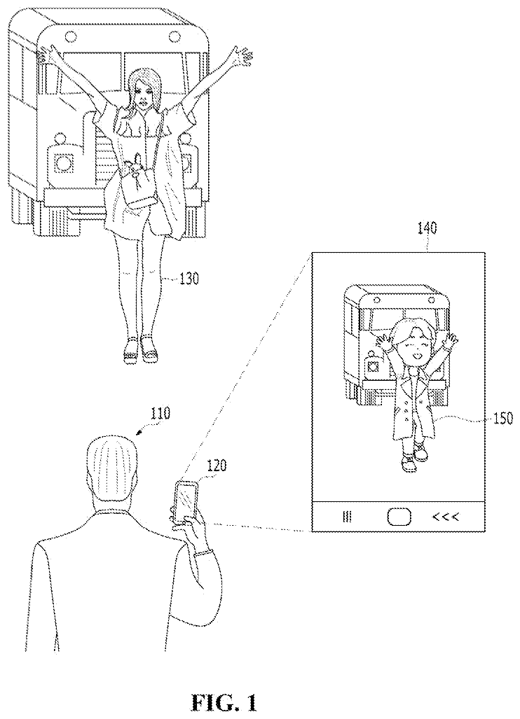

FIG. 1 is a diagram illustrating an example in which a user terminal 120 generates a synthesis image 140 in which a person object is replaced with an avatar image 150 according to an embodiment. As illustrated, a first user 110 may capture an image of a second user 130 using the user terminal 120. The user terminal 120 may replace the person object corresponding to the second user 130 in the captured image, with an avatar image 150 of the second user 130.

According to an embodiment, the user terminal 120 may recognize the shape of the second user 130 who is included in the captured image as the person object. Whether or not the object in the image is the person object may be determined by detecting a contour of the object and then using the shape of the contour. For example, in determining whether the object in the image is the person object, the user terminal 120 may use a database in which a plurality of contour shapes corresponding to a person object are stored, or may use a person object recognition module or the like generated through machine learning or the like. After that, the user terminal 120 may extract the skeleton information of the recognized person object from the captured image.

The user terminal 120 or a server (e.g., an information processing system 200) that interacts with the user terminal 120 may identify a user account associated with the person object recognized from the image captured through face recognition. For example, the user account may be a user account used in an instant messaging application. Specifically, the user terminal 120 or the server may compare a face area in the recognized person object with face information of a plurality of user accounts stored in a database (e.g., a local storage of the user terminal 120 or an external storage managed by the server). For example, the user terminal 120 or the server may compare the face area in the person object with, among the face information of a plurality of user accounts stored in the database, the face information of a user account associated with the user terminal 120 that captured the image, and with a user account of an acquaintance of the user account associated with the user terminal 120. In response to identifying the user account associated with the recognized person object, the user terminal 120 may acquire avatar information (e.g., avatar information of a representative avatar) associated with the identified user account.

According to an embodiment, the face information of the user account may be generated based on an image included in profile information of each user account. In addition, an image including a face similar to an image included in the profile information of the user account may be searched for and may be used to generate the face information of the corresponding user account. For example, an image including a face similar to the image included in the profile information of a specific user account may be searched for, from images, videos, or the like transmitted within a chat room in which the corresponding user account participates. Additionally or alternatively, the face information of the user account may be generated based on images, videos, and the like transmitted by each user account through the instant messaging application. Additionally or alternatively, the face information of the user account may be generated based on a video call image transmitted by each user account through the instant messaging application.

According to an embodiment, the user terminal 120 or the server may generate a background image by adaptively removing the recognized person object from the captured image. Specifically, the user terminal 120 may remove the person object by changing a pixel value in an area corresponding to the person object based on the pixel value in the area other than the area corresponding to the person object in the captured image. For example, the user terminal 120 or the server may generate a modified or constructed image by adaptively removing the person object from the captured image using a Generative Adversarial Network (GAN)-based image conversion model or the like.

After that, the user terminal 120 or the server may generate a synthesis image 140 using avatar information, skeleton information, and background image associated with the identified user account. Specifically, the user terminal 120 or the server may generate an avatar image 150 having the same or similar pose to the second user 130 by using the skeleton information, and generate the synthesis image 140 by inserting the generated avatar image 150 into the background image.

According to an embodiment, the user terminal 120 or the server may generate the synthesis image 140 when the first user 110 captures an image, a video, and the like using an in-app camera function in the instant messaging application. Additionally or alternatively, the user terminal 120 or the server may generate the synthesis image 140 when the first user 110 transmits an image, a video, or the like through the instant messaging application. Additionally or alternatively, the user terminal 120 or the server may generate the synthesis image 140 when the first user 110 performs a video call through the instant messaging application.

According to various embodiments of the present disclosure, since the user account is identified from the captured image through face recognition and the avatar associated with the identified user account is used, the synthesis image 140 may be generated without receiving input of information on the captured person, information on the avatar, or the like from a user. In addition, by adaptively removing the person object based on the background content excluding the person object, a natural synthesis image 140 can be generated even when the avatar image 150 having a body proportion different from that of an actual person is inserted. In addition, by synthesizing the avatar according to the skeleton information of the person object, it is possible to easily generate an avatar having the same or similar pose to the captured person without user input.

The user terminal 120 may perform all the functions described above, or alternatively, some or all of the functions described above may be performed by another external device, such as for example, an instant messaging service providing server, an avatar server, a face recognition server, an avatar synthesis server, and the like.

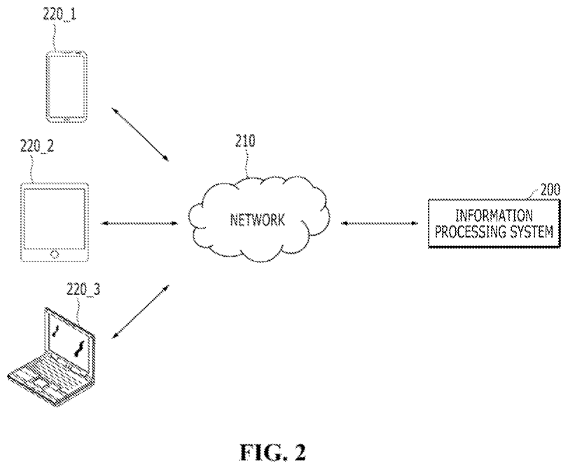

FIG. 2 is a schematic diagram illustrating a configuration in which an information processing system 200 is communicatively connected to a plurality of user terminals 220_1, 220_2 and 220_3 in order to generate a synthesis image in which the person object is replaced with the avatar according to an embodiment. The information processing system 200 may include a system capable of providing an instant messaging service including an avatar synthesis service through a network 210. According to an embodiment, the information processing system 200 may include one or more server devices and/or databases, or one or more distributed computing devices and/or distributed databases based on cloud computing services, which can store, provide and execute computer-executable programs (e.g., downloadable applications) and data relating to the instant messaging service and the generation of the synthesis image in which the person object is replaced with the avatar. The instant messaging service provided by the information processing system 200 may be provided to the user through the instant messaging application installed in each of the plurality of user terminals 220_1, 220_2 and 220_3. For example, the instant messaging service may include a text messaging service, a video call service, a speech call service, a video streaming service, an avatar synthesis service, a content evaluation service, and the like, between users of the instant messaging application.

The plurality of user terminals 220_1, 220_2 and 220_3 may communicate with the information processing system 200 through the network 210. The network 210 may be configured to enable communication between the plurality of user terminals 220_1, 220_2 and 220_3 and the information processing system 200. The network 210 may be configured as a wired network such as Ethernet, a wired home network (e.g., Power Line Communication), a telephone line communication device and Recommend Standard (RS)-serial communication, a wireless network such as a mobile communication network, a wireless LAN (WLAN), Wi-Fi, Bluetooth, and ZigBee, or a combination thereof, depending on the installation environment. The method of communication is not limited, and may include a communication method using a communication network (e.g., mobile communication network, wired Internet, wireless Internet, broadcasting network, satellite network, and the like) that may be included in the network 210 as well as short-range wireless communication between user terminals 220_1, 220_2 and 220_3.

In FIG. 2, a mobile phone terminal 220_1, a tablet terminal 220_2, and a PC terminal 220_3 are illustrated as the examples of the user terminals, but are not limited thereto, and the user terminals 220_1, 220_2 and 220_3 may be any computing device that is capable of wired and/or wireless communication and that can be installed with the instant messaging application and execute the same. For example, the user terminal may include a smart phone, a mobile phone, a navigation system, a computer, a notebook computer, a digital broadcasting terminal, Personal Digital Assistants (PDA), a Portable Multimedia Player (PMP), a tablet PC, a game console, a wearable device, an internet of things (IoT) device, a virtual reality (VR) device, an augmented reality (AR) device, and the like. In addition, FIG. 2 shows that three user terminals 220_1, 220_2 and 220_3 are in communication with the information processing system 200 through the network 210, but the present disclosure is not limited thereto, and a different number of user terminals may be configured to be in communication with the information processing system 200 through the network 210.

According to an embodiment, the information processing system 200 may generate the synthesis image in which the person object is replaced with the avatar in the image, through the instant messaging application running on the user terminals 220_1, 220_2 and 220_3. When the user account associated with the user terminal does not have an avatar, the information processing system 200 may search for the avatar most similar to the person object included in the image, and use the corresponding avatar to generate a synthesis image in which the person object is replaced with the avatar. When the user account has a plurality of avatars, the information processing system 200 may provide the avatar synthesis service by using a representative avatar of the user account. Alternatively, when the user account has a plurality of avatars, the information processing system 200 may request the user to select an avatar to be used for the avatar synthesis service.

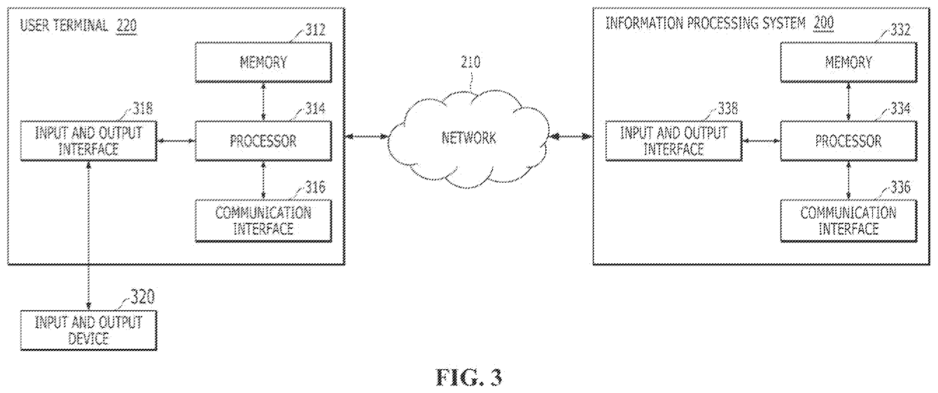

FIG. 3 is a block diagram illustrating an internal configuration of the user terminal 220 and the information processing system 200 according to an exemplary embodiment. The user terminal 220 may refer to any computing device that is capable of executing the instant messaging application and also capable of wired/wireless communication, and may include the mobile phone terminal 220_1, the tablet terminal 220_2, and the PC terminal 220_3 of FIG. 2, for example. As illustrated, the user terminal 220 may include a memory 312, a processor 314, a communication interface 316, and an input and output interface 318. Likewise, the information processing system 200 may include a memory 332, a processor 334, a communication interface 336, and an input and output interface 338. As shown in FIG. 3, the user terminal 220 and the information processing system 200 may be configured to communicate information and/or data through the network 210 using the respective communication interfaces 316 and 336. In addition, an input and output device 320 may be configured to input information and/or data to the user terminal 220 or to output information and/or data generated from the user terminal 220 through the input and output interface 318.

The memories 312 and 332 may include any non-transitory computer-readable recording medium. According to an embodiment, the memories 312 and 332 may include a permanent mass storage device such as random access memory (RAM), read only memory (ROM), disk drive, solid state drive (SSD), flash memory, and so on. As another example, a non-destructive mass storage device such as ROM, SSD, flash memory, disk drive, and so on may be included in the user terminal 220 or the information processing system 200 as a separate permanent storage device that is distinct from the memory. In addition, an operating system and at least one program code (e.g., a code for the instant messaging application, and the like installed and driven in the user terminal 220) may be stored in the memories 312 and 332.

These software components may be loaded from a computer-readable recording medium separate from the memories 312 and 332. Such a separate computer-readable recording medium may include a recording medium directly connectable to the user terminal 220 and the information processing system 200, and may include a computer-readable recording medium such as a floppy drive, a disk, a tape, a DVD/CD-ROM drive, a memory card, and so on, for example. As another example, the software components may be loaded into the memories 312 and 332 through the communication interfaces 316 and 336 rather than the computer-readable recording medium. For example, at least one program may be loaded into the memories 312 and 332 based on a computer program (for example, an application that provides instant messaging application services) installed by files provided by the developers or a file distribution system for distributing an installation file of the application through the network 210.

The processors 314 and 334 may be configured to process instructions of the computer program by performing basic arithmetic, logic, and input and output operations. The instructions may be provided to the processors 314 and 334 from the memories 312 and 332 or the communication interfaces 316 and 336. For example, the processors 314 and 334 may be configured to execute the received instructions according to program code stored in a recording device such as the memories 312 and 332.

The communication interfaces 316 and 336 may provide a configuration or function for the user terminal 220 and the information processing system 200 to communicate with each other through the network 210, and may provide a configuration or function for the user terminal 220 and/or the information processing system 200 to communicate with another user terminal or another system (e.g., a separate cloud system or the like). For example, a request or data (e.g., request for avatar synthesis, skeleton information extracted from the person object, a background image from which the person object is removed, a synthesis image in which the person object is replaced with the avatar, and the like) generated by the processor 314 of the user terminal 220 according to the program code stored in the recording device such as the memory 312 or the like, may be transmitted to the information processing system 200 through the network 210 under the control of the communication interface 316. Conversely, a control signal or instructions provided under the control of the processor 334 of the information processing system 200 may be received by the user terminal 220 through the communication interface 316 of the user terminal 220 via the communication interface 336 and the network 210. For example, the user terminal 220 may receive, from the information processing system 200 and through the communication interface 316, the avatar information associated with the identified user account, the skeleton information extracted from the person object, the background image from which the person object is removed, the synthesis image in which the person object is replaced with the avatar, and the like.

The input and output interface 318 may be a means for interfacing with the input and output device 320. As an example, the input device may include a device such as a camera, a keyboard, a microphone, and a mouse, which includes an audio sensor and/or an image sensor, and the output device may include a device such as a display, a speaker, a haptic feedback device, and so on. As another example, the input and output interface 318 may be a means for interfacing with a device such as a touch screen or the like that integrates a configuration or function for performing inputting and outputting. For example, when the processor 314 of the user terminal 220 processes the instructions of the computer program loaded in the memory 312, a service screen or an image obtained by synthesizing a user avatar, which is configured with the information and/or data provided by the information processing system 200 or other user terminals, may be displayed on the display through the input and output interface 318. While FIG. 3 illustrates that the input and output device 320 is not included in the user terminal 220, the present embodiment is not limited thereto, and the input and output device 320 may be configured as one device with the user terminal 220. In addition, the input and output interface 338 of the information processing system 200 may be a means for interfacing with a device for inputting or outputting, which may be connected to the information processing system 200 or included in the information processing system 200. In FIG. 3, the input and output interfaces 318 and 338 are illustrated as the components configured separately from the processors 314 and 334, but are not limited thereto, and the input and output interfaces 318 and 338 may be configured to be included in the processors 314 and 334.

The user terminal 220 and the information processing system 200 may include more components than the components illustrated in FIG. 3. According to an embodiment, the user terminal 220 may be implemented to include at least a part of the input and output devices 320 described above. In addition, the user terminal 220 may further include other components such as a transceiver, a global positioning system (GPS) module, a camera, various sensors, a database, and the like. For example, when the user terminal 220 is a smartphone, it may generally include components included in the smartphone, and for example, it may be implemented such that various components such as an acceleration sensor, a gyro sensor, a camera module, various physical buttons, buttons using a touch panel, input and output ports, a vibrator for vibration, and so on are further included in the user terminal 220.

According to an embodiment, the processor 314 of the user terminal 220 may be configured to operate an instant messaging application or a web browser application providing the instant messaging service including an avatar synthesis image generation service. The program code associated with the corresponding application may be loaded into the memory 312 of the user terminal 220. While the application is running, the processor 314 of the user terminal 220 may receive information and/or data provided from the input and output device 320 through the input and output interface 318 or receive information and/or data from the information processing system 200 through the communication interface 316, and process the received information and/or data and store it in the memory 312. In addition, such information and/or data may be provided to the information processing system 200 through the communication interface 316.

While the instant messaging application is running, the processor 314 may receive text, image, video, and the like input or selected through the input device such as a camera, a microphone, and the like including a touch screen, a keyboard, an audio sensor and/or an image sensor connected to the input and output interface 318, and store the received text, image, and/or video or the like in the memory 312, or provide it to the information processing system 200 through the communication interface 316 and the network 210. According to an embodiment, the processor 314 may provide the captured image received through the input device to the information processing system 200 through the network 210 and the communication interface 316.

Alternatively, the processor 314 may extract the skeleton information of the person object included in the captured image, generate a background image from which the person object is removed, and then receive avatar information of the user account associated with the person object included in the captured image from the information processing system 200 to generate a synthesis image based on the background image and the avatar information.

The processor 334 of the information processing system 200 may be configured to manage, process, and/or store the information and/or data received from a plurality of user terminals and/or a plurality of external systems. According to an embodiment, the processor 334 may identify the user account associated with the person object included in the image, and search for avatar information associated with the identify user account, based on the captured image received from the user terminal 220. In addition, the image from which the person object is removed, that is, the background image may be generated, and the skeleton information of the person object may be extracted. According to an embodiment, based on the avatar information associated with the user account, the skeleton information, and the background image from which the person object is removed, the processor 334 may generate a synthesis image in which the person object is replaced with the avatar.

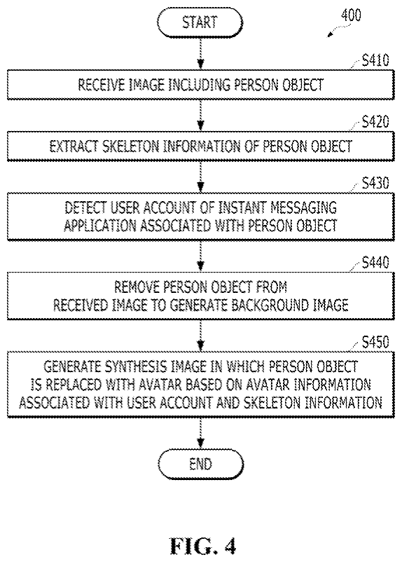

FIG. 4 is a flowchart illustrating a method 400 for providing an avatar service according to an embodiment. According to an embodiment, the method 400 for providing an avatar service may be performed by the information processing system (e.g., by the processor of the information processing system). According to another embodiment, the method 400 for providing an avatar service may be performed by the user terminal (e.g., by the processor of the user terminal). For example, when the database storing the face information of the user account(s) and the avatar information associated with the user account are stored in the user terminal, the user terminal may perform all steps of the method 400 for providing an avatar service. According to still another embodiment, the information processing system (e.g., the processor of the information processing system) and the user terminal (e.g., the processor of the user terminal) may divide and perform the steps of the method 400 for providing an avatar service.

As illustrated, the method 400 for providing an avatar service may be initiated by a processor receiving an image including a person object, in operation S410. The processor may correspond to the processor 314 of the user terminal 220 or the processor 334 of the information processing system 200. For example, the processor may receive the image including the person object from the user terminal through the instant messaging application running on the user terminal. Alternatively, the processor may receive the image including the person object from an image sensor (e.g., a camera) mounted in the user terminal, or may receive the image from an external device.

In response to receiving the image, the processor may extract the skeleton information of the person object included in the image, in operation S420. According to an embodiment, the processor may determine whether or not the size of the area corresponding to the person object is equal to or greater than a preset threshold value, and extract the skeleton information of the person object only when the size of the area corresponding to the person object is equal to or greater than the threshold value. When a plurality of person objects are recognized from the image, whether or not the size of the area corresponding to each object is equal to or greater than a preset threshold value may be determined. As another example, when a plurality of person objects are recognized from the image, whether or not the size of the corresponding area is equal to or greater than a preset threshold value may be determined only for the object having the largest corresponding area for the object. In this case, the preset threshold value may be associated with an absolute size of the area or a relative value of the area with respect to the overall recognized image size, or the like. With such a configuration, it is possible to prevent the occurrence of additional processing time (e.g., skeleton information extraction, associated user account identification, and the like) due to a person object (e.g., a person in the background) unintentionally included by a capturer among the person objects included in the image.

The processor may identify a user account of the instant messaging application associated with the person object in the image, in operation S430. Specifically, the processor may recognize a face area in the recognized person object, and compare the recognized face area with the face information of the user account of the instant messaging application associated with the user terminal. Additionally or alternatively, the processor may recognize the face area in the recognized person object, and compare the recognized face area with the face information of a user account of an acquaintance of the user account of the instant messaging application associated with the user terminal. According to an embodiment, in response to determining that there is no avatar information associated with the user account, the processor may search for an avatar having the highest similarity to the person object in the image. The processor may determine that a Euclidean distance between the person object and each of a plurality of pre-stored avatars in a vector space, and may identify the avatar which has the shortest Euclidean distance as the avatar having the highest similarity between the person object. In this case, the processor may use the avatar determined to have the highest similarity to the person object as the avatar of the user account. According to another embodiment, in response to determining that there is no avatar information associated with the user account, the processor may not replace the person object in the image with an avatar, or may replace the person object with a default avatar or an avatar selected from a plurality of default avatars according to a user input.

According to an embodiment, the face information of the user account associated with the user terminal may be generated based on an image included in profile information of the user account associated with the user terminal. Additionally or alternatively, the face information of the user account associated with the user terminal may be generated based on a video call image received from the user terminal. Additionally or alternatively, the face information of the user account associated with the user terminal may be generated based on an image, a video, or the like transmitted by the corresponding user account through the instant messaging application.

The processor may remove the person object from the image received from the user terminal (or from the image sensor of the user terminal) to generate a background image, in operation S440. According to an embodiment, the processor may change a pixel value in the area corresponding to the person object based on the pixel value in the area other than the area corresponding to the person object in the image. For example, the processor may generate a modified or reconstructed image in which the person object is adaptively removed from the image using a GAN-based image conversion model or the like.

The processor may generate a synthesis image in which the person object is replaced with an avatar based on the avatar information associated with the user account and the skeleton information, in operation S450. According to an embodiment, the processor may convert the skeleton information of the person object into avatar skeleton information based on the avatar information associated with the user account. In particular, the processor may generate an avatar image based on the avatar skeleton information and the avatar information, and insert the generated avatar image into the background image to generate a synthesis image in which the person object is replaced with an avatar. With such a configuration, since the skeleton information of the person object is changed in accordance with the avatar having a different body ratio from the real person, an avatar image naturally having the same or similar pose to the person object can be generated.

In another example embodiment, operation S430 may be omitted, or a user account associated with the person object may not be identified in operation S430. When a user associated with the person object is not identified, the person object may be replaced with a default avatar or a user's selected avatar to generate the synthesis image, in operation S450. In generating the synthesis image in operation S450, a pose and a size of the avatar may be set based on the skeleton information which indicates the pose and the size of the person object in the original image.

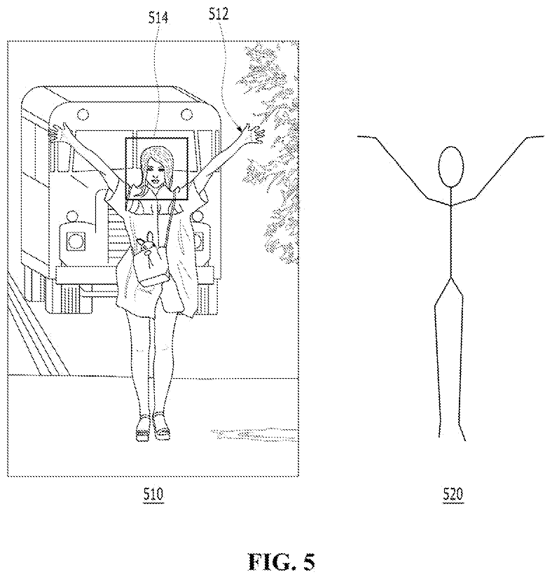

FIG. 5 is a diagram illustrating an example of extracting the skeleton information of the person object from the image according to an embodiment. As illustrated, the image 510 may be an image obtained by capturing a specific person. According to an embodiment, the processor may recognize a shape of the person included in the image 510 as a person object 512. Specifically, whether or not the object in the image is the person object may be determined by detecting a contour of the object and then using the shape of the contour.

When the person object is detected in the image 510, the processor may recognize a face area 514 of the detected person object 512, and identify a user account associated with the person object 512 (e.g., a user account of the instant messaging application). After that, the processor may extract the skeleton information 520 of the recognized person object 512 from the image 510. As illustrated, the skeleton information may be information representing the size of the face, lengths of the arms and legs, the pose, and the like of the person object 512 using straight lines and curves. In FIG. 5, the image 510 is illustrated as including one person object 512, but is not limited thereto. For example, when the image includes a plurality of person objects, the processor may extract the skeleton information of each person object. Additionally, the processor may be configured to extract the skeleton information only for the person object having the largest size, or extract the skeleton information only for the person object having a size equal to or greater than a preset threshold value.

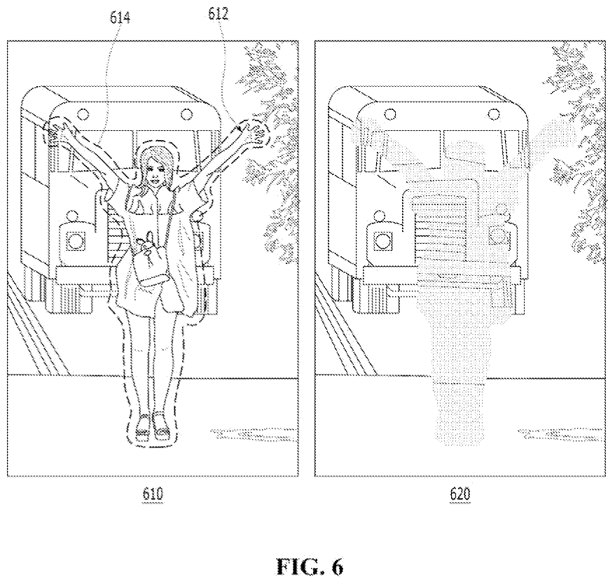

FIG. 6 is a diagram illustrating an example of removing a person object 612 from an image 610 to generate a background image 620 according to an embodiment. As illustrated, the processor may recognize the person object 612 included in the image 610 and adaptively remove a first area 614 corresponding to the recognized person object 612 to generate the background image 620. According to an embodiment, the processor may change the pixel value in the first area 614 corresponding to the person object 612 based on the pixel value in a second area (e.g., a remaining area) other than the first area 614 in the image 610. For example, the pixel value of an area corresponding to the head of the person object 612 may be changed in accordance with the pixel value of a nearby or boundary area (e.g., a window portion of the bus) of the head. Additionally or alternatively, the processor may generate a modified or reconstructed image in which the person object 612 is adaptively removed from the image 610 using a GAN-based image conversion model or the like.

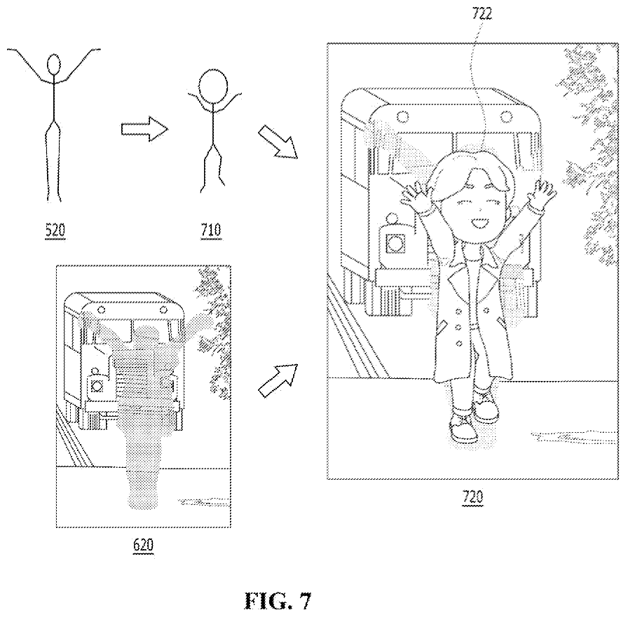

With such a configuration, since the area 614 corresponding to the person object 612 is removed and the pixel value based on the surrounding content is input to the corresponding area, the background image 620 from which the person object 612 is naturally removed can be generated. As illustrated, in the background image 620, an upper body portion of the person object 612 is replaced with pixel values similar to the bus portion of the background, and a lower body portion is replaced with pixel values similar to the road portion of the background, so that the person object 612 can be removed naturally. Based on the background image 620, a high-quality synthesis image (see a synthesis image 720 in FIG. 7) may be generated even when an avatar image having a body proportion of the head, arms, legs, and the like different from the person object 612 is inserted into the background image.

FIG. 7 is a diagram illustrating an example of generating a synthesis image 720 by converting the skeleton information 520 of the person object into avatar skeleton information 710 according to an embodiment. According to an embodiment, since the avatar has a body proportion (e.g., head, arms, legs, and the like) different from that of a real person, the processor may obtain avatar information (e.g., body proportion of the avatar, avatar three-dimensional (3D) model information, and the like) associated with the identified user account, and convert the skeleton information 520 of the person object into the avatar skeleton information 710 based on the obtained avatar information. As illustrated, the avatar skeleton information 710 may have a larger head size and shorter arm and leg lengths compared to the skeleton information 520 of the person object, and have the same pose as the skeleton information 520 of the person object.

After that, the processor may generate an avatar image 722 having the same or similar pose to the person object (e.g., the person object 512 in FIG. 5) based on the obtained avatar information and avatar skeleton information 710. The processor may generate a synthesis image 720 in which the person object (the person object 512 in FIG. 5) is replaced with the avatar image 722 by inserting the generated avatar image 722 into the background image 620. In particular, the avatar image 722 may be inserted at a position where the person object (the person object 512 in FIG. 5) was located. For example, the position of toes of the avatar image 722 may be aligned with the position of the toes of the person object (the person object 512 in FIG. 5) and/or the position of the top of the head of the avatar image 722 may be aligned with the position of the top of the head of the person object (the person object 512 in FIG. 5).

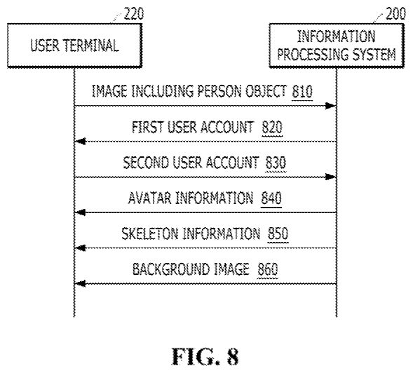

FIG. 8 is a diagram illustrating an example in which the information processing system 200 transmits and receives information to and from the user terminal 220 according to an embodiment. As illustrated, the information processing system 200 may receive an image 810 including a person object from the user terminal 220 through the instant messaging application. According to an embodiment, in response to receiving the image 810, the information processing system 200 may detect information 820 about a first user account (e.g., user account of the instant messaging application) associated with the person object included in the image 810. The information processing system 200 may transmit the detected information 820 on the first user account to the user terminal 220 through the instant messaging application.

The user terminal 220 may provide the received information 820 on the first user account to the user through the display. When the information processing system 200 incorrectly recognizes the person object in the image 810, the user terminal 220 may transmit information on an accurate user account (e.g., information about a second user account 830) related to the person object, to the information processing system 200 through the instant messaging application, based on a user input for providing the accurate user account.

The information processing system 200 may obtain the avatar information 840 associated with the second user account based on the received information 830 on the second user account, and transmit the obtained avatar information 840 to the user terminal 220 through the instant messaging application. In addition, the information processing system 200 may extract skeleton information 850 of the person object from the received image 810, and transmit the extracted skeleton information 850 to the user terminal 220 through the instant messaging application. Additionally, the information processing system 200 may generate a background image 860 in which the person object is adaptively removed from the received image 810, and transmit the generated background image 860 to the user terminal 220 through the instant messaging application. The user terminal 220 may generate a synthesis image in which the person object is replaced with an avatar based on the avatar information 840, the skeleton information 850, and the background image 860 received from the information processing system 200.

In an another example, the information processing system 200 may omit transmitting the avatar information 840, the skeleton information 850 and the background image 860 to the user terminal 200. Instead, the information processing system 200 may generate the synthesis image based on the avatar information 840, the skeleton information 850 and the background image 860, and may transmit the synthesis image to the user terminal 220.

According to an embodiment, the accuracy of face recognition may be improved by receiving feedback (e.g., information of the second user account 830) on a misrecognized person object from the user terminal 220 and re-training the face recognition model based on the corresponding information. In FIG. 8, the information processing system 200 is illustrated as transmitting the information 820 on the first user account to the user terminal 220 and receive the information 830 on the second user account, but is not limited thereto. For example, in response to determining that the person object is a side view or a back view of the person, the information processing system 200 may transmit a message requesting information on the user account associated with the person object to the user terminal 220 through the instant messaging application. In particular, the information processing system 200 may determine the person object to be the side view or the back view of the person when the face is rotated by a predetermined angle (e.g., 60 degrees) or more from the front. To this end, the information processing system 200 may calculate a face rotation angle by analyzing positions, sizes, and the like of the eyes, nose, mouth, and the like in the face area. Alternatively, in response to determining that the person object is the side view or the back view of the person, the information processing system 200 may not replace the person object with an avatar.

Additionally or alternatively, when the user account associated with the person object is not identified, the information processing system 200 may transmit a message requesting information on the user account associated with the person object to the user terminal 220 through the instant messaging application. In this case, the information processing system 200 may receive a user account associated with the person object from the user terminal 220 and replace the person object with an avatar even when it is difficult to detect or identify the associated user account. With such a configuration, the accuracy of face recognition can be improved by re-training the face recognition model using user input information.

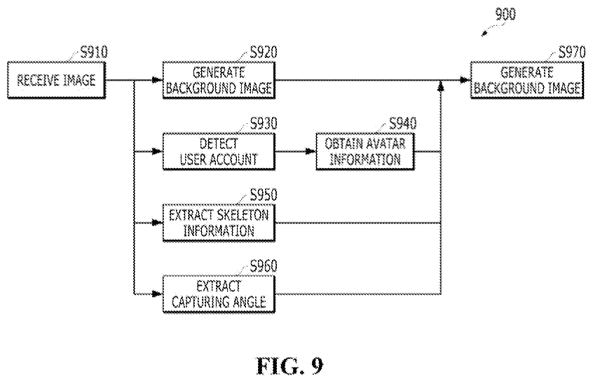

FIG. 9 is a flowchart illustrating an example of a method 900 for generating a synthesis image in which a person object is replaced with an avatar based on an image capturing angle according to an embodiment. The image capturing angle may refer to an angle of a camera at the time when the image is captured by the camera. When the camera is mounted in the user terminal 220, the camera angle may represent an angle of the user terminal 220 at the time when the image is captured. According to an embodiment, the method 900 for generating a synthesis image may be initiated by the processor receiving an image, in operation S910. The processor may generate a background image by adaptively removing an area corresponding to a person object in the image, in operation S920. Further, the processor may identify a user account of the instant messaging application associated with the person object included in the image, in operation S930. The processor may acquire avatar information (e.g., body ratio of an avatar, 3D model information of an avatar, and the like) associated with the identified user account, in operation S940.

Additionally, the processor may extract skeleton information of the person object from the image, in operation S950. In addition, the processor may extract capturing angle information from the image, in operation S960. According to an embodiment, the capturing angle information may be included in the image as metadata or the like. According to another embodiment, the processor may analyze the image to estimate the capturing angle information. In this case, a machine learning model obtained by training the machine learning model based on an image in association with a camera angle in large quantities may be used.

The processor may generate a synthesis image from the received image, in which the person object is replaced with an avatar based on the background image, the avatar information, the skeleton information, and the capturing angle information, in operation S970. With such a configuration, it is possible to generate an avatar image reflecting perspective by the differences in capturing angle, distortion, size difference, and the like. Accordingly, it is possible to generate an avatar image more similar to the shape of the captured person object. For example, a capturer may capture an image by emphasizing a specific body part (e.g., head, legs, arms, and the like) of a person object according to capturing angle, and generate an avatar image reflecting such intention.

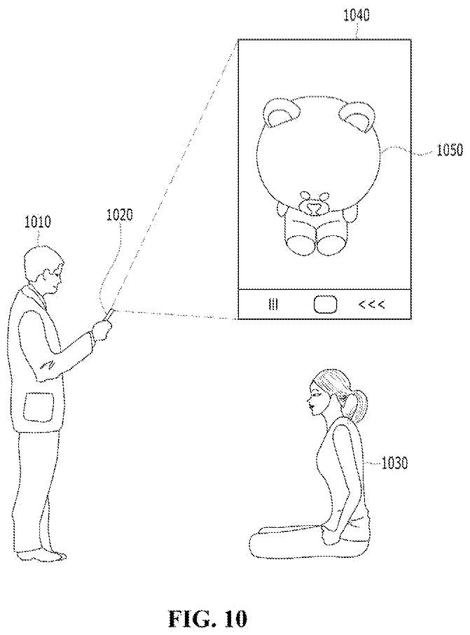

FIG. 10 is a diagram illustrating an example of replacing a person object with an avatar by reflecting a capturing viewpoint of a camera according to an embodiment. As illustrated, a first user 1010 may capture an image of a second user 1030 using a user terminal 1020. For example, the first user 1010 may capture the image of the second user 1030 by tilting the user terminal 1020 at an angle of 50 degrees. According to an embodiment, the processor may additionally use the capturing angle information at the time of image capturing into consideration, when generating the avatar image 1050. For example, the capturing angle information may be included in the image as metadata.

Specifically, the processor may extract skeleton information of the person object and identify a user account associated with the person object. In addition, the processor may generate a background image, which is the captured image from which the person object included therein is removed. After that, the processor may generate a synthesis image 1040 in which the person object is replaced with an avatar image 1050 based on the background image, the skeleton information, the avatar information associated with the user account, and the capturing angle information. Accordingly, the avatar image 1050 may not only have the same pose as the captured person object, but also reflect the perspective according to the capturing viewpoint (that is, capturing angle), distortion, size difference, and the like of the camera.

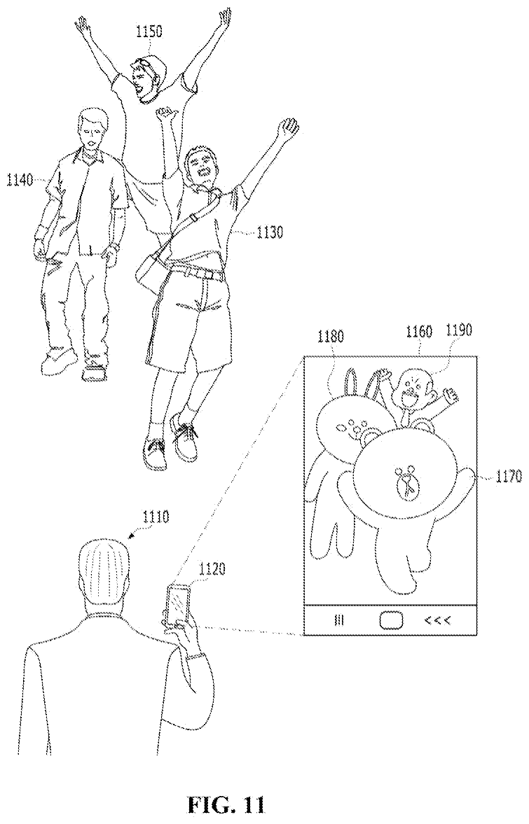

FIG. 11 is a diagram illustrating an example in which three users 1130, 1140 and 1150 are captured, in which avatars are rendered in the order of the users appearing in front, according to an embodiment. As illustrated, a first user 1110 may capture an image of a second user 1130, a third user 1140, and a fourth user 1150 using a user terminal 1120. The processor may determine the order of the second user 1130, the third user 1140, and the fourth user 1150 appearing in front, and may generate a synthesis image 1160 including an avatar 1170 of the second user, an avatar 1180 of the third user, and an avatar 1190 of the fourth user according to the determined front-appearance order information.

Specifically, the processor may extract skeleton information of the person objects and identify a user account associated with each person object. Additionally, the processor may determine differences in depth between the person objects in the image. For example, the processor may compare the position of the feet of the person objects, compare the size of the faces of the person objects, or use depth information (e.g., depth image, depth map, and the like) included in the image to determine the depth differences between the person objects. In addition, the processor may generate a background image, which is the captured image from which the person objects included therein are removed.

After that, the processor may generate a synthesis image 1160 in which the three person objects are replaced with the avatars 1170, 1180, 1190 based on the background image, the skeleton information of each person object, the avatar information associated with each user account, and the depth difference information. As illustrated, the avatar 1180 of the third user may be displayed on the avatar 1190 of the fourth user, and the avatar 1170 of the second user may be displayed on the avatar 1180 of the third user. With such a configuration, the synthesis image 1160 reflecting the front-behind positions of the people may be generated.

Additionally or alternatively, when it is determined that the distance between the users included in the image is within a preset distance, or that the shapes of the users (that is, the person objects) overlap with each other more than a preset area, the processor may generate a reduced avatar image. With this configuration, it is possible to prevent a phenomenon in which the avatar at the back is excessively obscured by the avatars at the front.

The method for providing an avatar service described above may be implemented as a computer-readable code on a computer-readable recording medium. The computer-readable recording medium includes all kinds of recording devices in which data readable by a computer system is stored. Examples of computer-readable recording medium include ROM, RAM, CD-ROM, magnetic tape, floppy disks, and optical data storage devices, and the like. In addition, the computer-readable recording medium may be distributed over network coupled computer systems so that the computer-readable code is stored and executed in a distributed manner. Further, programmers in the technical field pertinent to the present disclosure will be easily able to envision functional programs, codes and code segments to implement the embodiments.

The methods, operations, or techniques of this disclosure may be implemented by various means. For example, these techniques may be implemented in hardware, firmware, software, or a combination thereof. Those skilled in the art will further appreciate that the various illustrative logical blocks, modules, circuits, and algorithm steps described in connection with the disclosure herein may be implemented in electronic hardware, computer software, or combinations of both. To clearly illustrate this interchangeability of hardware and software, various illustrative components, blocks, modules, circuits, and steps have been described above generally in terms of their functionality. Whether such a function is implemented as hardware or software varies depending on design requirements imposed on the particular application and the overall system. Those skilled in the art may implement the described functions in varying ways for each particular application, but such implementation should not be interpreted as causing a departure from the scope of the present disclosure.

In a hardware implementation, processing units used to perform the techniques may be implemented in one or more ASICs, DSPs, digital signal processing devices (DSPDs), programmable logic devices (PLDs), field programmable gate arrays (FPGAs), processors, controllers, microcontrollers, microprocessors, electronic devices, other electronic units designed to perform the functions described in the disclosure, computer, or a combination thereof.

Accordingly, various example logic blocks, modules, and circuits described in connection with the disclosure may be implemented or performed with general purpose processors, DSPs, ASICs, FPGAs or other programmable logic devices, discrete gate or transistor logic, discrete hardware components, or any combination of those designed to perform the functions described herein. The general purpose processor may be a microprocessor, but in the alternative, the processor may be any conventional processor, controller, microcontroller, or state machine. The processor may also be implemented as a combination of computing devices, for example, a DSP and microprocessor, a plurality of microprocessors, one or more microprocessors associated with a DSP core, or any other combination of the configurations.

In the implementation using firmware and/or software, the techniques may be implemented with instructions stored on a computer-readable medium, such as random access memory (RAM), read-only memory (ROM), non-volatile random access memory (NVRAM), programmable read-only memory (PROM), erasable programmable read-only memory (EPROM), electrically erasable PROM (EEPROM), flash memory, compact disc (CD), magnetic or optical data storage devices, and the like. The instructions may be executable by one or more processors, and may cause the processor(s) to perform certain aspects of the functions described in the present disclosure.

When implemented in software, the techniques may be stored on a computer-readable medium as one or more instructions or codes, or may be transmitted through a computer-readable medium. The computer-readable media include both the computer storage media and the communication media including any medium that facilitates the transfer of a computer program from one place to another. The storage media may also be any available media that may be accessed by a computer. By way of non-limiting example, such a computer-readable medium may include RAM, ROM, EEPROM, CD-ROM or other optical disk storage, magnetic disk storage or other magnetic storage devices, or any other media that can be used to transfer or store desired program code in the form of instructions or data structures and can be accessed by a computer. Also, any connection is properly referred to as a computer-readable medium.

For example, when the software is transmitted from a website, server, or other remote sources using coaxial cable, fiber optic cable, twisted pair, digital subscriber line (DSL), or wireless technologies such as infrared, wireless, and microwave, the coaxial cable, the fiber optic cable, the twisted pair, the digital subscriber line, or the wireless technologies such as infrared, wireless, and microwave are included within the definition of the medium. The disks and the discs used herein include CDs, laser disks, optical disks, digital versatile discs (DVDs), floppy disks, and Blu-ray disks, where disks usually magnetically reproduce data, while discs optically reproduce data using a laser. The combinations described above should also be included within the scope of the computer-readable media.

The software module may reside in, RAM memory, flash memory, ROM memory, EPROM memory, EEPROM memory, registers, hard disk, removable disk, CD-ROM, or any other form of storage medium known. An exemplary storage medium may be connected to the processor, such that the processor may read or write information from or to the storage medium. Alternatively, the storage medium may be integrated into the processor. The processor and the storage medium may exist in the ASIC. The ASIC may exist in the user terminal. Alternatively, the processor and storage medium may exist as separate components in the user terminal.

Although the embodiments described above have been described as utilizing aspects of the currently disclosed subject matter in one or more standalone computer systems, the present disclosure is not limited thereto, and may be implemented in conjunction with any computing environment, such as a network or distributed computing environment. Furthermore, aspects of the subject matter in this disclosure may be implemented in multiple processing chips or devices, and storage may be similarly influenced across a plurality of devices. Such devices may include PCs, network servers, and portable devices.

The foregoing exemplary embodiments are merely exemplary and are not to be construed as limiting. The present teaching can be readily applied to other types of apparatuses. Also, the description of the exemplary embodiments is intended to be illustrative, and not to limit the scope of the claims, and many alternatives, modifications, and variations will be apparent to those skilled in the art.

What is claimed is:

1. A method for providing an avatar service, performed by one or more processors, the method comprising:
receiving an original image including a first person object from a user terminal through an instant messaging application;
extracting skeleton information of the first person object, from the original image;
identifying a first user account of the instant messaging application associated with the first person object; and
removing the first person object from the original image to convert the original image to a background image.

2. The method according to claim 1, further comprising:
generating a synthesis image in which the first person object is replaced with an avatar based on first avatar information associated with the first user account and the skeleton information of the first person object.

3. The method according to claim 1, further comprising:
transmitting first avatar information associated with the first user account, the skeleton information of the first person object, and the background image to the user terminal.

4. The method according to claim 1, wherein the removing the first person object from the original image to generate the background image comprises:
changing, in the original image, a first pixel value in a first area corresponding to the first person object based on a second pixel value in a second area other than the first area corresponding to the first person object.

5. The method according to claim 1, wherein the identifying the first user account of the instant messaging application associated with the first person object comprises:
comparing a face area in the first person object with face information of the first user account of the instant messaging application associated with the user terminal.

6. The method according to claim 5, further comprising:
obtaining the face information of the first user account based on at least one of an image included in profile information of the first user account and at least one video call image received from the user terminal.

7. The method according to claim 1, wherein the identifying the first user account of the instant messaging application associated with the first person object comprises:
comparing a face area in the first person object with face information of a second user account of an acquaintance of the first user account.

8. The method according to claim 2, wherein the generating the synthesis image comprises:
converting the skeleton information of the first person object into avatar skeleton information based on the first avatar information;
generating an avatar image based on the avatar skeleton information and the first avatar information; and
inserting the avatar image into the background image.

9. The method according to claim 1, further comprising:
in response to determining that there is no avatar information associated with the first user account, searching for an avatar having a highest similarity to the first person object by calculating a Euclidean distance between the first person and each of a plurality of pre-stored avatars.

10. The method according to claim 1, wherein the original image comprises information of a camera angle indicating an angle of a camera at a time when the original image is captured by the camera, and
wherein the method further comprises:
generating a synthesis image in which the first person object is replaced with an avatar based on first avatar information associated with the first user account, the skeleton information of the first person object, and the information of the camera angle.

11. The method according to claim 1, further comprising:
estimating a camera angle of the original image; and
generating a synthesis image in which the first person object is replaced with an avatar based on first avatar information associated with the first user account, the skeleton information of the first person object, and the camera angle.

12. The method according to claim 2, wherein the original image further comprises a second person object, and
wherein the method further comprises:
extracting skeleton information of the second person object, from the original image;
detecting a second user account of the instant messaging application associated with the second person object; and
determining a difference in depth between the first person object and the second person object in the original image,
wherein the removing the first person object from the original image to convert the original image to the background image comprises:
removing the second person object from the original image to convert the original image to the background image, and
wherein the generating the synthesis image comprises:
generating the synthesis image based on the first avatar information, second avatar information associated with the second user account, the skeleton information of the first person object, the skeleton information of the second person object, and the difference in depth.

13. The method according to claim 12, wherein the determining the difference in depth between the first person object and the second person object in the original image comprises at least one of:
comparing a first foot position of the first person object with a second foot position of the second person object;
comparing a first face size of the first person object with a second face size of the second person object; and
comparing a first image depth of the first person object and a second image depth of the second person object based on depth information included in the original image.

14. The method according to claim 1, wherein the detecting the first user account of the instant messaging application associated with the first person object comprises:
in response to determining that the first person object is at least one of a side view and a back view of a first person, transmitting a message requesting information on the first user account associated with the first person object to the user terminal through the instant messaging application.

15. The method according to claim 1, wherein the identifying the first user account of the instant messaging application associated with the first person comprises:
transmitting, as identified user account information, the first user account to the user terminal through the instant messaging application; and
receiving, as corrected user account information, a second user account that is different from the first user account, from the user terminal through the instant messaging application.

16. The method according to claim 1, wherein the extracting the skeleton information of the first person object comprises:
determining whether or not a size of an area corresponding to the first person object is equal to or greater than a preset threshold value.

17. A method for providing an avatar service, performed by one or more processors, the method comprising:
receiving an original image including a person object;
transmitting the original image to an external device through an instant messaging application;
obtaining skeleton information of the person object;
receiving avatar information associated with the person object from the external device;
obtaining a background image in which the person object is removed from the original image; and
generating a synthesis image in which the person object in the original image is replaced with an avatar, based on the skeleton information, the avatar information, and the background image.

18. The method according to claim 17, wherein the generating the synthesis image comprises:
converting the skeleton information of the person object into avatar skeleton information based on the avatar information;
generating the avatar based on the avatar skeleton information and the avatar information; and
inserting the avatar into the background image.

19. The method according to claim 17, wherein the original image comprises information of a camera angle indicating an angle of a camera at a time when the original image is captured by the camera, and
wherein the generating the synthesis image comprises:
generating the synthesis image based on the avatar information, the skeleton information of the person object, and the information of the camera angle.

20. The method according to claim 17, wherein the obtaining the skeleton information of the person object comprises:
receiving the skeleton information of the person object from the external device, or extracting the skeleton information of the person object from the original image, and
wherein the obtaining the background image comprises:
when the skeleton information of the person object is received from the external device, receiving the background image from the external device; and
when the one or more processors have extracted the skeleton information from the original image, generating the background image by removing the person object from the original image.

21. A server for providing an avatar service, the server comprising:
one or more memories configured to store one or more instructions; and
one or more processors configured to execute the one or more instructions to:
receive an original image including a person object, from a user terminal through an instant messaging application;
extract skeleton information of the person object, from the original image;
identify a user account of the instant messaging application associated with the person object; and
convert the original image to a background image by removing the person object from the original image.
